(19) United States
(12) Patent Application Publication
(10) Pub. No.: US 2022/0040739 A1
(43) Pub. Date: Feb. 10, 2022

(54) Adhesive Strip for Grout Cleaning

(71) Applicants: Arushi Tiwari, Audubon, PA (US); Arnav Tiwari, Audubon, PA (US)

(72) Inventors: Arushi Tiwari, Audubon, PA (US); Arnav Tiwari, Audubon, PA (US)

(21) Appl. No.: 16/988,614

(22) Filed: Aug. 8, 2020

(51) Int. Cl. B08B 1/00; B32B 7/12; B32B 3/26; B32B 5/02; B08B 3/08

(52) U.S. Cl. CPC B08B 1/001; B32B 7/12; B32B 3/266; B32B 5/024; B32B 2432/00; B32B 2255/26; B32B 2307/726; B32B 2250/02; B08B 3/08

(57) ABSTRACT

The present invention provides a grout space cleaning apparatus composed of an adhesive strip with a thin convex absorbent pad on the front side that is coated in cleansing agent particulates. The strip is adhesive on the side containing the convex absorbent pad. This strip can be taped on top of grout spaces and sprayed with water or any other suitable liquid on top. The liquid will seep through the holes in the adhesive backing strip, dissolve the cleansing agent particulates and effectively clean the grout space.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The cleaning of grout spaces between bathroom, kitchen, floor tiles and the like is a difficult task. Conventional mops, cloths, sponges, pads, and other cleaning tools cannot reach effectively into grout spaces (the concave area between contiguous tiles) in order to properly clean them due to their narrow nature. This often leads to excessive dirt, grime, mold, and mineral build up, despite cleaning efforts. In order to combat this problem a variety of specifically grout oriented cleaning supplies have been invented. For example, in U.S Pat. No. 721,018 B1 a Grout Cleaning Sponge is described by Mark E. Kirby. This sponge includes a “plurality of rows of elongate convexities” to reach into grout spaces for more effective cleaning. Another grout oriented cleaning tool is the Cleaning Sheet described by Wong et al. in U.S Pat. No. 2005006135A1. This invention provides a cleaning sheet with 3-D “pillow members” that direct dirt and grime to specific zones of the cleaning sheet and can conform to different cleaning surface topographies, allowing for more effective cleaning. There also exist systems in which long absorbent strings are soaked in bleach and then used around corners and sometimes in grout spaces. However, all these inventions discussed still lead to exposure to toxic bleach/cleaning agent fumes, and a considerable amount of physical exertion. What is needed is a cleaning apparatus that can efficiently and directly target grout spaces with cleansing agents. The invention must also reduce exposure to toxic fumes, and minimize the physical exertion put into cleaning grout spaces. The apparatus must also minimize the possibility of cleansing agent runoff, thus more effectively protecting designs and artwork in bathroom spaces.

### FIELD OF INVENTION

The present disclosure relates, in general, to tools used for tile cleaning. Specifically, it relates to an adhesive strip apparatus for targeted cleaning of grout and tile spaces.

### SUMMARY OF THE INVENTION

The longstanding need for an efficient and safe method to clean spaces between adjacent tiles is addressed by this novel invention. This invention includes a long adhesive strip (5-10 ft., but length is variable), made of a woven fabric, a flexible plastic polymer, or any other flexible yet resilient material. The adhesive strip is such that it can be removed when a slight pull is applied, similar to the functionality of a Band-Aid. Attached to the side with the adhesive substance, will be a long thin convex absorbent pad (thin enough to fit into a grout space) in the center laterally. There will be variably sized holes in the adhesive strip backing of the absorbent pad, across the center laterally, for water to permeate through. The absorbent pad will have bleach and detergent particulates coated on it as well. With this design, the apparatus can be taped on top of a grout space with the absorbent pad reaching deeper into the space, water can be sprayed on top of it, and the water will permeate through the holes, seep into the absorbent pad, dissolve the bleach and detergent particulates and effectively clean the grout spaces. The apparatus can be removed 10-20 minutes later, and the area can be rinsed down with water. This apparatus reduces the physical effort required currently to clean grout spaces and minimizes exposure of the user to toxic cleaning agent fumes. It also effectively targets grout spaces directly while protecting the surrounding areas on the wall.

### BRIEF DESCRIPTION OF DRAWINGS

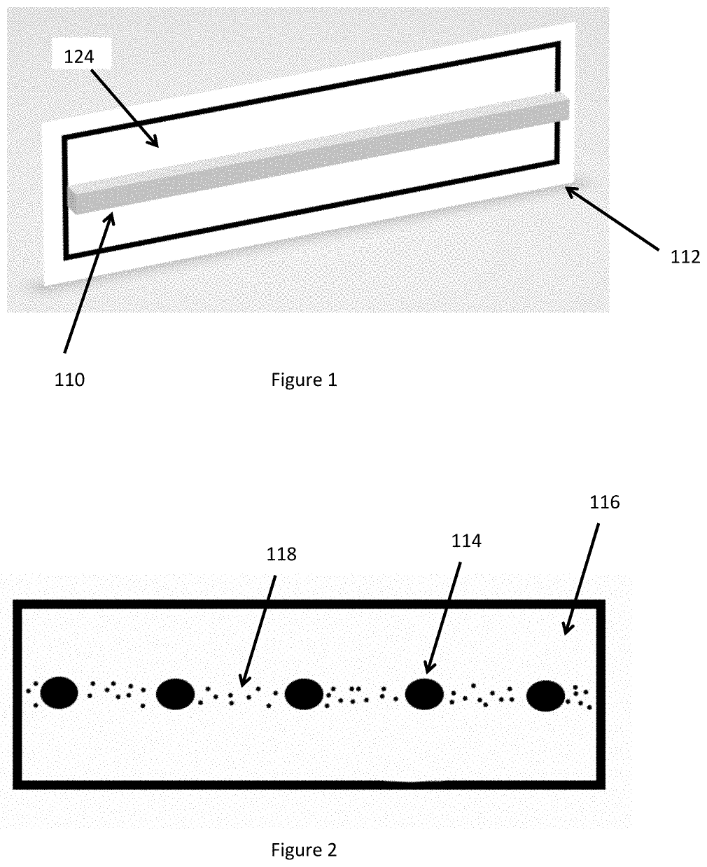

1. FIG. 1 is a front view showing the convex absorbent pad aligned along the lateral center of the adhesive strip

2. FIG. 2 shows a back view of the adhesive strip displaying the holes that will be present in the adhesive strip (large and small) to allow water to permeate and absorb into the convex absorbent pad

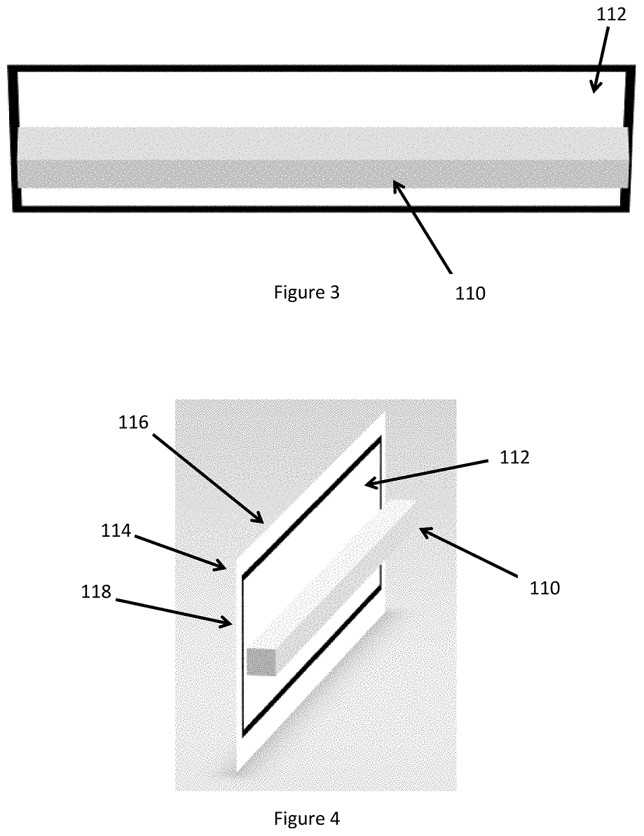

3. FIG. 3 is a top view of the inner side of the adhesive strip displaying the convex absorbent pad jutting out for insertion in a grout space

4. FIG. 4 is a side view of the adhesive strip displaying the convex absorbent pad jutting out for insertion into a grout space.

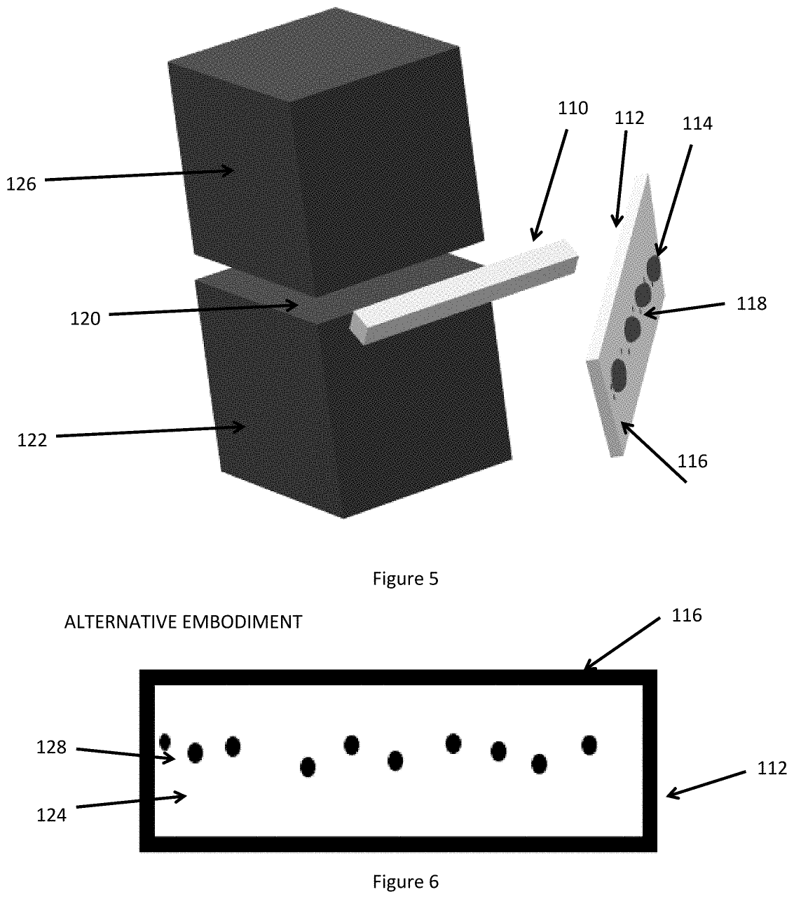

5. FIG. 5 is an exploded view showing the convex absorbent pad detached from the adhesive strip. The convex absorbent pad will be inserted into the grout space between the exploded tiles, and the adhesive strip would be attached to the back of the convex absorbent pad.

6. FIG. 6 is depicting an alternative embodiment of the invention, in which there is an adhesive strip without a convex absorbent pad. The cleansing agent is present directly on the adhesive side of the adhesive strip in the lateral center section.

### DETAILED DESCRIPTION

Referring to FIGS. 1, 3, and 4 it can be seen that the adhesive strip member as a whole is referred to as number 112 and the convex absorbent pad for reaching into the grout space is denoted number 110. The adhesive strip 112 is made of a woven fabric or a flexible plastic polymer such as polyethylene or polyurethane. An adhesive strip 112 made of any other type of plastic, fabric, or other flexible, malleable, yet resilient material is within the scope of this invention. The front side of the adhesive strip 124 is coated in an adhesive substance such as an acrylate including methacrylates and epoxy diacrylates (also known as vinyl resins). The adhesive strip 112 can be on any reasonable length depending on one's individual needs, but is typically between 5 to 10 feet long. The front side 124 may be coated in any other adhesive substance such that it is strong enough to stick to a wall, floor, or any other tiled area when a slight pressure is applied, but can also be pulled off when slight pressure is applied, similar to the adhesion of a Band-Aid. The convex absorbent pad denoted by 110 is firmly attached to the front side of the adhesive strip 124, preferably in the lateral center, but can be attached in any orientation on the adhesive strip. It can be attached to the adhesive strip using superglue or any other strong adhesive substance that will not come undone easily when pressure is applied. Convex absorbent pad 110 can be composed of any water or liquid absorbing material that can conform to fit in a grout space, or is specifically made to a pre-determined size to fit into a grout space. The convex absorbent pad 110 can be made to any reasonable pre-determined size such that it can fit into a grout space and be attached to the adhesive side of the adhesive strip 124. Convex absorbent pad 110 is coated with bleach and detergent solid particulates. Any safe concentration of cleaning agent on the absorbent pad is within the scope of this invention. The cleaning agent on the absorbent pad can be detergent particles, bleach, or any other applicable cleaning agent, whether used traditionally for cleaning or not. For example, baking soda particles could be applied on the absorbent pad and any solution of vinegar could be used as the spray. Any such traditional or non-traditional cleaning agent may be used with this setup. The convex absorbent pad may have a thin, porous polymer coating to keep it from sticking to the grout space. 110 and 112 can be made to any variable length and height, such that it is reasonable for use over a grout space in a kitchen, bathroom, floor, wall, countertop, or other tiled area. As depicted in FIG. 2 the backside of the adhesive strip 116 will have large holes denoted by 114 and smaller holes denoted by 118. Holes 114 and 118 can be made to any reasonable size and arrangement and can be made in any combination such that the attachment of an convex absorbent pad 110 on the front side of the adhesive strip 124 is still possible and such that when water is sprayed on the back side 116 of the adhesive strip, the water can permeate through the adhesive strip and be absorbed into the convex absorbent pad 110. Ideally, the holes will be made in the lateral center of the back side 116 and the convex absorbent pad 110 will be attached directly opposite in the lateral center of the front side 112. However, the holes can be made anywhere on the backing strip. FIG. 5 shows an exploded view of how the adhesive strip 112 and the convex absorbent pad 110 will be applied to a grout space. The exploded tiles are denoted by 122 and 126 and the grout space between them is denoted by 120. The adhesive strip 112 is separated from the convex absorbent pad 110 in this view. When the tiles are joined the grout space 120 becomes a narrow concavity between the tiles that is difficult to reach and clean effectively. This space can have excessive dirt, grime, or mineral buildup. FIG. 5 shows how the convex absorbent pad 110 is inserted into the grout space, and the adhesive strip 112 is covering on top of the convex absorbent pad 110. Once the adhesive strip 112 is stuck securely on top of the grout space with the convex absorbent pad 110 reaching into the grout space, water can be generously sprayed on top of the strip. The water will permeate through the holes 114 and 118 and be absorbed into the convex absorbent pad 110. The bleach and detergent particles on the absorbent pad will dissolve and thoroughly clean the grout space around them. After 10-20 minutes or any other desired time interval enough to allow the particulates to clean the grout space, the adhesive strip is torn off and thrown away and the exposed area can now be rinsed with water. An alternative embodiment of this invention is an adhesive strip 112 without a convex absorbent pad. In this embodiment, the cleansing agent particulates 128 would be attached directly to the front of the adhesive strip 124 in the lateral center section of the adhesive strip 112 as shown in FIG. 6. This apparatus can be used by taping the adhesive strip on top of a grout space and applying pressure using a finger or any other tool to push the lateral center section of the adhesive into the grout space. This embodiment will ensure that cleansing agent is directed into the grout space for more thorough cleaning as well.

1. A grout cleaning apparatus, comprising:
an adhesive strip member with holes across it;
a thin convex absorbent pad member attached to the adhesive side of said adhesive strip; and,
a cleansing agent in particulate, powder, detergent, liquid, disinfectant, or other form coated on said convex absorbent pad.

2. A grout cleaning apparatus as recited in claim 1, wherein the entirety of the said adhesive strip is fabricated of a woven fabric, a plastic polymer, or any other type of plastic, fabric, or flexible, malleable, yet resilient and water-resistant material

3. A grout cleaning apparatus as recited in claim 2, where in the said adhesive strip is adhesive on one side, and non-adhesive on the other

4. A grout cleaning apparatus as recited in claim 3, wherein the said holes on the said adhesive strip are made across the lateral center of said adhesive strip

5. A grout cleaning apparatus as recited in claim 4, wherein the convex absorbent pad is attached across the lateral center of the said adhesive strip

6. A grout cleaning apparatus as recited in claim 5, wherein the convex absorbent pad is of width and length that is suitable to fit inside a grout space

7. A grout cleaning apparatus as recited in claim 6, wherein the convex absorbent pad has a thin, porous polymer coating to keep it from sticking to the grout space

8. A grout cleaning apparatus, comprising:
an adhesive strip member;
a thin convex absorbent pad member attached to the adhesive side of said adhesive strip; and,
a cleansing agent in particulate, powder, detergent, liquid, disinfectant, or other form coated on said convex absorbent pad.

9. A grout cleaning apparatus as recited in claim 8, wherein the top and bottom section of the said adhesive strip are fabricated of a woven fabric, a plastic polymer, or any other type of plastic, fabric, or flexible, malleable, yet resilient and water-resistant material, and lateral middle section is fabricated of a water-permeable material

10. A grout cleaning apparatus as recited in claim 9, where in the said adhesive strip is adhesive on one side, and non-adhesive on the other

11. A grout cleaning apparatus as recited in claim 10, wherein the convex absorbent pad is attached across the lateral center of the said adhesive strip

12. A grout cleaning apparatus as recited in claim 11, wherein the convex absorbent pad is of width and length that is suitable to fit inside a grout space

13. A grout cleaning apparatus as recited in claim 12, wherein the convex absorbent pad has a thin, porous polymer coating to keep it from sticking to the grout space

14. A grout cleaning apparatus, comprising:
an adhesive strip member;
a cleansing agent in particulate, powder, detergent, liquid, disinfectant, or other form coated on said adhesive strip.

15. A grout cleaning apparatus as recited in claim 14, wherein the top and bottom section of the said adhesive strip are fabricated of a woven fabric, a plastic polymer, or any other type of plastic, fabric, or flexible, malleable, yet resilient and water-resistant material, and lateral middle section is fabricated of a water-permeable material.

16. A grout cleaning apparatus as recited in claim 15, wherein the cleansing agent particulates are attached to the adhesive side of the adhesive strip.

17. A grout cleaning apparatus as recited in claim 16 wherein the cleansing agent particulates are attached in the lateral center of the said adhesive strip, such that they line up with the grout space when the said adhesive strip is taped on the tiles.
